(19) United States
(12) Patent Application Publication
(10) Pub. No.: US 2016/0075052 A1
(43) Pub. Date: Mar. 17, 2016

(54) APPARATUS AND METHOD FOR MANUFACTURING AN ELECTRICITY STORAGE MATERIAL

(71) Applicant: JTEKT CORPORATION, Osaka-shi (JP)

(72) Inventors: Takumi MIO, Kariya-shi (JP); Koji Nishi, Anjo-shi (JP); Sachiko Kubota, Nagoya-shi (JP)

(73) Assignee: JTEKT CORPORATION, Osaka-shi (JP)

(21) Appl. No.: 14/851,264

(22) Filed: Sep. 11, 2015

(30) Foreign Application Priority Data
Sep. 12, 2014 (JP) 2014-186481

(51) Int. Cl. B29B 7/82; H01M 10/04; H01M 4/04; H01M 10/0525

(52) U.S. Cl. CPC B29B 7/82; H01M 10/0525; H01M 10/04; H01M 4/04

(57) ABSTRACT

An apparatus for manufacturing an electricity storage material includes: a dissolving device that dissolves a thickener in a solvent; a viscosity adjusting device that adjusts viscosity of the solution of the thickener; a stirring device that mixes the solution of the thickener adjusted in viscosity and powder of an active substance to produce a first mixture, and stirs the first mixture to produce a second mixture; a heating device that heats the solution of the thickener or the first mixture by the time the stirring of the first mixture is started after the solution of the thickener is produced, so as to heat the solution of the thickener contained in the first mixture; and a kneading device that kneads the solution of the thickener and the powder of the active substance which are contained in the second mixture to produce a third mixture.

### INCORPORATION BY REFERENCE

The disclosure of Japanese Patent Application No. 2014-186481 filed on Sep. 12, 2014 including the specification, drawings and abstract, is incorporated herein by reference in its entirety.

### BACKGROUND OF THE INVENTION

1. Field of the Invention

The present invention relates to an apparatus and a method for manufacturing an electricity storage material.

2. Description of the Related Art

In recent years, lithium ion secondary batteries have been used for hybrid vehicles, electric vehicles, etc. Electrodes of the lithium ion secondary batteries are manufactured by first kneading powder of an active substance etc. and a solution of a thickener to produce slurry of an active material (electricity storage material), and then applying the slurry to a base material such as aluminum foil and drying the slurry. The lithium ion secondary batteries are manufactured by cutting the electrodes into a predetermined size, stacking the resultant electrodes with a separator interposed therebetween, and enclosing the stack and a non-aqueous electrolyte in a packaging material. Japanese Patent Publication No. H08-24043 (JP H08-24043 B) and Japanese Patent No. 2979641 (JP 2979641) describe a method for producing powder of an active substance for a positive electrode by mixing a lithium compound and manganese dioxide and heating the mixture at about 400° C. to 500° C.

Due to poor wettability of powder of an active substance with a solution of a thickener, a mixture of the powder of the active substance and the solution of the thickener tends to be deposited in a manufacturing apparatus. It is therefore difficult to feed the mixture, hindering continuous production of slurry.

### SUMMARY OF THE INVENTION

It is one object of the present invention to provide an apparatus and a method for manufacturing an electricity storage material which can improve wettability of powder of an active substance with a solution of a thickener.

According to a first aspect of the present invention, an apparatus for manufacturing an electricity storage material includes: a dissolving device that dissolves a thickener in a solvent; a viscosity adjusting device that adjusts viscosity of a solution produced by dissolving the thickener in the solvent by the dissolving device; a stirring device that mixes the solution of the thickener adjusted in viscosity by the viscosity adjusting device and powder of an active substance to produce a first mixture, and stirs the first mixture to produce a second mixture; a heating device that heats the solution of the thickener or the first mixture by the time the stirring device starts stirring the first mixture after the dissolving device produces the solution of the thickener, so that the solution of the thickener contained in the first mixture has already been heated when the stirring device stirs the first mixture; and a kneading device that kneads the solution of the thickener and the powder of the active substance which are contained in the second mixture produced by the stirring device to produce a third mixture.

The solution of the thickener has already been heated when stirred together with the powder of the active substance. Accordingly, the viscosity of the solution of the thickener is reduced, and the wetting rate of the powder of the active substance with the solution of the thickener is increased. Since the powder of the active substance is easily wetted with the solution of the thickener, the mixture of the solution of the thickener and the powder of the active substance is not deposited in the manufacturing apparatus and can therefore be smoothly fed. Due to the improved wettability of the powder of the active substance with the solution of the thickener, the powder of the active substance is quickly dispersed in the solution of the thickener, and damage to the powder of the active substance can be suppressed. Since the powder of the active substance is uniformly dispersed in the solution of the thickener, quality of electrodes can be improved, and battery performance can be enhanced.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic configuration diagram of an apparatus for manufacturing an electricity storage material according to an embodiment of the invention;

FIG. 2A is a first flowchart illustrating processing that is performed by a control device of the apparatus for manufacturing an electricity storage material according to the embodiment of the invention;

FIG. 2B is a second flowchart illustrating the processing that is performed by the control device of the apparatus for manufacturing an electricity storage material according to the embodiment of the invention;

FIG. 3 is a diagram showing the relationship between the viscosity of a solution of a thickener and the temperature of the solution of the thickener and the relationship between the surface tension of water and the temperature of water;

FIG. 4 is a diagram showing the relationship between the settling time of an active substance and the temperature of the solution of the thickener;

FIG. 5 is a diagram showing the relationship between the viscosity of the solution of the thickener and the dissolution rate to solubility of the thickener in a solvent;

FIG. 6 is a diagram showing respective changes in viscosity of the solution of the thickener with time in the case of dissolving the thickener by using microwaves, a stirring force, and heating;

FIG. 7 is a diagram showing the relationship between the viscosity of final slurry of an active material and the viscosity of the solution of the thickener;

FIG. 8 is a diagram showing respective changes in viscosity of the solution of the thickener with time in the case of performing viscosity adjustment by using ultrasonic waves and a stirring force;

FIG. 9 is a diagram showing the relationship between the capacity retention rate of a battery, i.e., durability (repeating charge-discharge characteristics) of the battery, and the viscosity of the slurry of the active material; and

FIG. 10 is a diagram showing the relationship between the capacity retention rate of the battery and the cumulative collision energy of particles of the active material.

### DETAILED DESCRIPTION OF EMBODIMENTS

An embodiment of the present invention will be described below with reference to the accompanying drawings.

An apparatus and a method for manufacturing an electricity storage material according to the embodiment form, e.g., an apparatus and a method for manufacturing electrodes (positive and negative electrodes) of lithium ion secondary batteries. Electrodes of lithium ion secondary batteries are manufactured by applying slurry of an active material serving as an electricity storage material to a base material such as aluminum foil or copper foil and drying the slurry. The apparatus and the method for manufacturing an electricity storage material according to the present embodiment are an apparatus and a method for manufacturing slurry of an active material.

For positive electrodes, specific examples of the active material include lithium-nickel oxide etc. as an active substance (solid component), N-methylpyrrolidone etc. as a solvent (liquid component), acetylene black etc. as a conductive agent, and polyvinylidene fluoride etc. as a binder. For negative electrodes, specific examples of the active material include graphite etc. as an active substance (solid component), water as a solvent (liquid component), carboxymethyl cellulose etc. as a thickener, and SRB rubber, polyacrylic acid, etc. as a binder. The active material for negative electrodes will be described below.

Poor wettability of powder of the active substance with a solution of the thickener hinders continuous kneading of the powder of the active substance and the solution of the thickener. It is therefore necessary to improve the wettability, namely increase the wetting rate, of the powder of the active substance with the solution of the thickener. The wetting rate can be given by the wetting angle and the viscosity of the solution of the thickener. The wetting angle is given by the surface tension of the powder of the active substance and the surface tension of the solution of the thickener.

Methods to increase the wetting rate include increasing the surface tension of the powder of the active substance to increase the wetting angle, reducing the surface tension of the solution of the thickener to increase the wetting angle, and reducing the viscosity of the solution of the thickener. The surface tension of the powder of the active substance can be increased by carrying out surface modification by ultraviolet radiation. The surface tension of the solution of the thickener can be reduced by increasing the temperature of the solution of the thickener or adding a surfactant to the solution of the thickener. The viscosity of the solution of the thickener can be reduced by increasing the temperature of the solution of the thickener or changing the molecular weight of the solution of the thickener. Increasing the temperature of the solution of the thickener is particularly effective in increasing the wetting rate because it can reduce both the surface tension and the viscosity of the solution of the thickener.

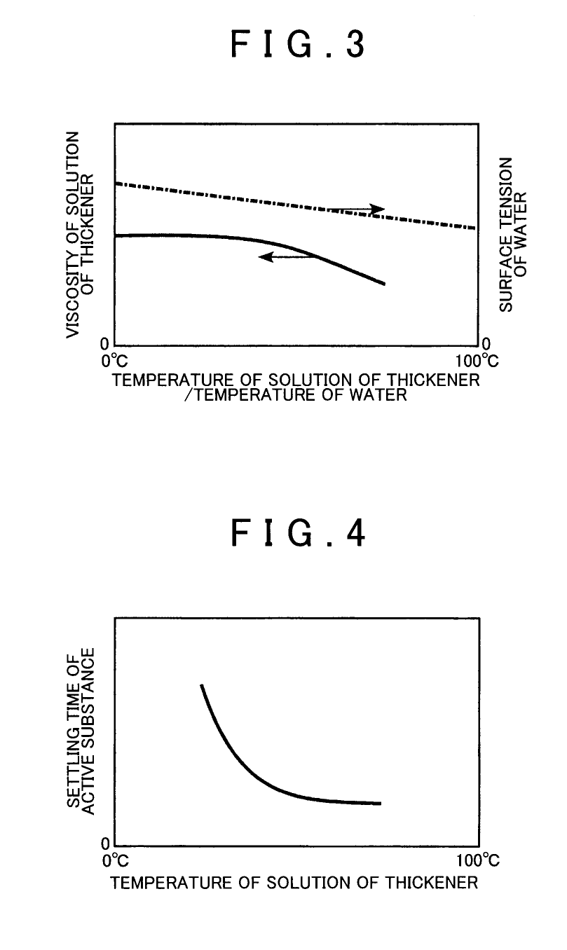

Experiments were carried out to see how the viscosity of the solution of the thickener would change with an increase in temperature of the solution of the thickener. The result of the experiments show that the viscosity of the solution of the thickener decreases with an increase in temperature of the solution of the thickener, as shown by a continuous line in FIG. 3. For reference, FIG. 3 also shows how the surface tension of water changes with an increase in temperature of water by an alternate long and short dash line. The surface tension of water decreases with an increase in temperature of water. Since a solvent dissolving the thickener is water, the surface tension of the solution of the thickener similarly decreases with an increase in temperature of the solution of the thickener.

Experiments were carried out to see how the wetting rate of the powder of the active substance with the solution of the thickener would change with an increase in temperature of the solution of the thickener. The wetting rate was evaluated by pouring the powder of the active substance onto the surface of the solution of the thickener and measuring the settling time of the powder of the active substance, namely the time it took for the powder of the active substance to settle to the bottom of the solution of the thickener. The result of the experiments show that the settling time of the powder of the active substance in the solution of the thickener decreases with an increase in temperature of the solution of the thickener, as shown in FIG. 4. The wettability of the powder of the active substance with the solution of the thickener can thus be significantly improved, and battery performance can further be improved.

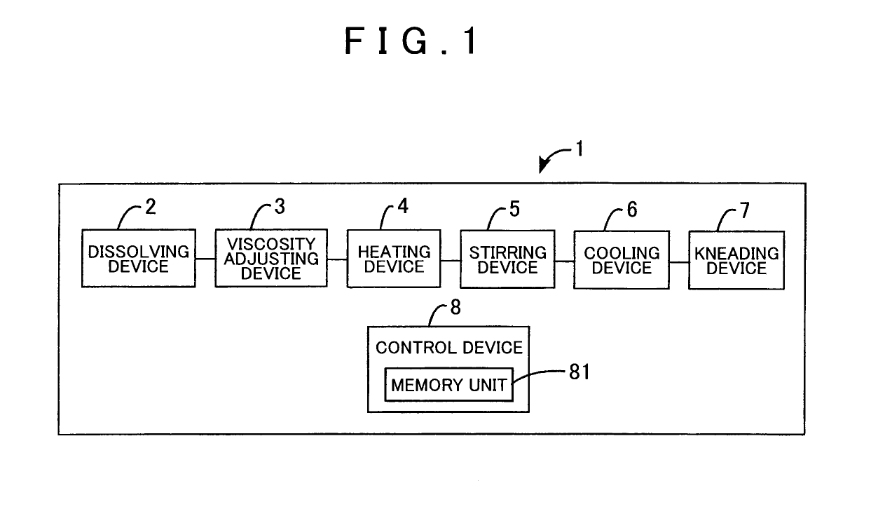

The apparatus for manufacturing an electricity storage material according to the present embodiment will be described with reference to FIG. 1. An apparatus 1 for manufacturing an electricity storage material includes a dissolving device 2, a viscosity adjusting device 3, a heating device 4, a stirring device 5, a cooling device 6, a kneading device 7, a control device 8, etc.

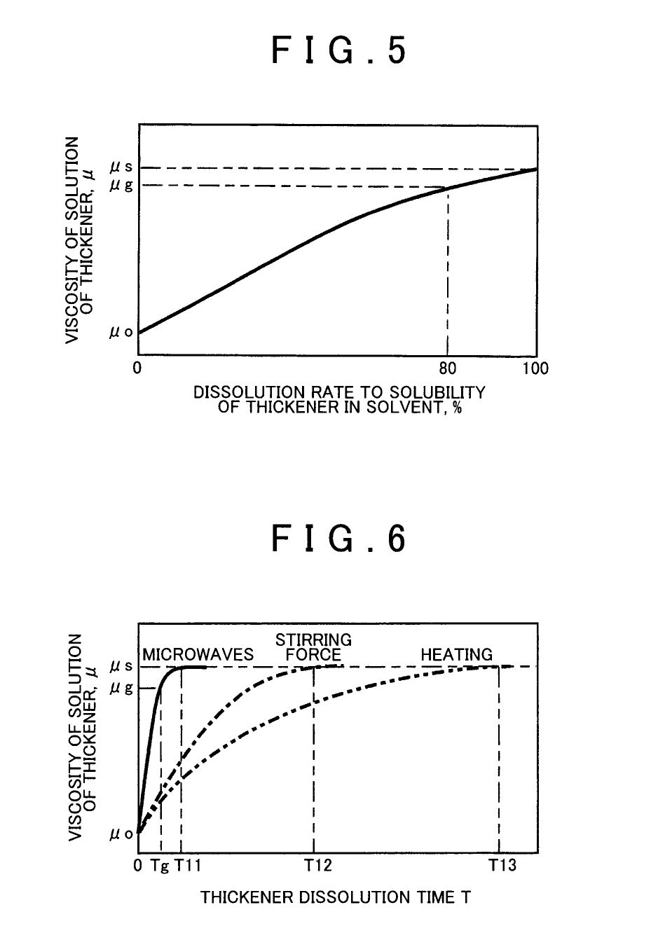

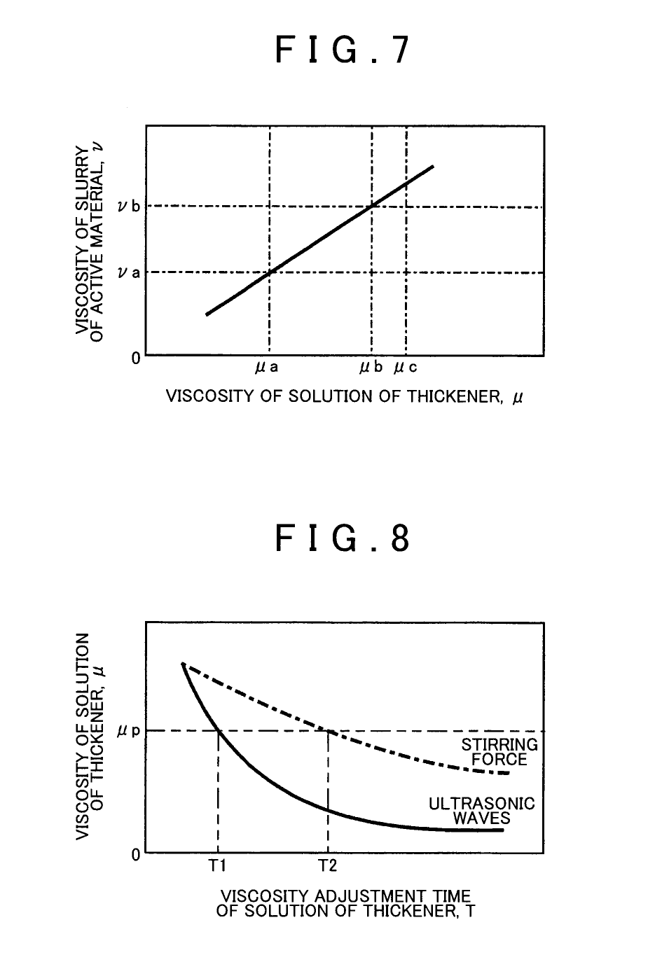

The control device 8 is a device that controls driving etc. of the dissolving device 2, the viscosity adjusting device 3, the heating device 4, the stirring device 5, the cooling device 6, and the kneading device 7. A memory unit 81 of the control device 8 stores data showing the relationship between the viscosity of the solution of the thickener and the temperature of the solution of the thickener (see FIG. 3), data showing the relationship between the viscosity of the solution of the thickener and the dissolution rate to solubility of the thickener in the solvent (see FIG. 5), data showing the relationship between the viscosity of the solution of the thickener and the dissolution time of the thickener (see FIG. 6), data showing the relationship between the viscosity of the slurry of the active material and the viscosity of the solution of the thickener (see FIG. 7), data showing the relationship between the viscosity of the solution of the thickener and the viscosity adjustment time of the solution of the thickener (see FIG. 8), and other data relating to kneading control etc. As used herein, the “dissolution rate to solubility” refers to the rate of the mass of solute dissolved in a certain amount of solvent to solubility (the maximum mass of solute that can be dissolved in the solvent).

The dissolving device 2 is a device that dissolves the thickener in the solvent in a housing. The dissolving device 2 includes a microwave device having a magnetron. The control device 8 drives the microwave device to generate microwaves and applies the microwaves to the solvent supplied into the housing to dissolve the thickener in the solvent.

The viscosity adjusting device 3 is a device that adjusts the viscosity of the solution of the thickener dissolved by the dissolving device 2 in a housing. The viscosity adjusting device 3 includes an ultrasonic device having an ultrasonic wave generating element such as a piezoelectric element. The control device 8 drives the ultrasonic device to generate ultrasonic waves and applies the ultrasonic waves to the solution of the thickener supplied into the housing to adjust the viscosity of the solution of the thickener. That is, the control device 8 decides the viscosity of the solution of the thickener based on the viscosity of the final slurry of the active material and controls viscosity adjustment by applying the ultrasonic waves for a predetermined time so that the solution of the thickener has the decided viscosity.

The heating device 4 is a device that heats the solution of the thickener adjusted in viscosity by the viscosity adjusting device 3 in a housing. The heating device 4 includes an electrical heating wire made of nichrome etc. and a temperature measuring device such as a thermocouple. The control device 8 applies a current to the electrical heating wire to cause the electrical heating wire to generate heat, and heats the solution of the thickener supplied into the housing to temporarily reduce the viscosity of the solution of the thickener. The heating device 4 may include an element other than the electrical heating wire such as a heat pump as long as the element has a heating function.

The stirring device 5 is a device that mixes and stirs the solution of the thickener heated by the heating device 4 and powder of the active substance in a housing. The stirring device 5 includes stirring blades that are rotated by a motor. The control device 8 drives the motor to rotate the stirring blades, so that the stirring device 5 mixes the solution of the thickener and the powder of the active substance introduced into the housing to produce a first mixture, and stirs the first mixture to produce a second mixture.

The cooling device 6 is a device that cools the second mixture produced by the stirring device 5 in a housing. The cooling device 6 includes a heat pump and a temperature measuring device such as a thermocouple. The control device 8 operates the heat pump to cool the second mixture supplied into the housing so as to increase the viscosity of the solution of the thickener contained in the second mixture, namely so as to bring the viscosity of the solution of the thickener contained in the second mixture back to the viscosity adjusted by the viscosity adjusting device 3. The cooling device 6 may include an element other than the heat pump such as a Peltier element as long as the element has a cooling function.

The kneading device 7 is a device that kneads the solution of the thickener and the powder of the active substance which are contained in the second mixture cooled by the cooling device 6 in a housing to produce a third mixture. The kneading device 7 includes stirring blades that are rotated by a motor. The control device 8 drives the motor to rotate the stirring blades, so that the kneading device 7 stirs and kneads the mixture supplied into the housing to produce the slurry of the active material. As described in detail later, a kneading index is set based on kinetic energy of particles of the active material, the mean free path of the particles of the active material, and a kneading time for the active material. The control device 8 sets kneading conditions so that the set kneading index is equal to or lower than a target value, and controls kneading of the active material according to the set kneading conditions.

As used herein, “mixing in the stirring device 5” means adding the powder of the active substance to the solution of the thickener, “stirring in the stirring device 5” means stirring the first mixture (preliminary kneading) and refers to the state before cooling the solution of the thickener, and “kneading in the kneading device 7” means kneading the second mixture (main kneading) and refers to the state after cooling the solution of the thickener.

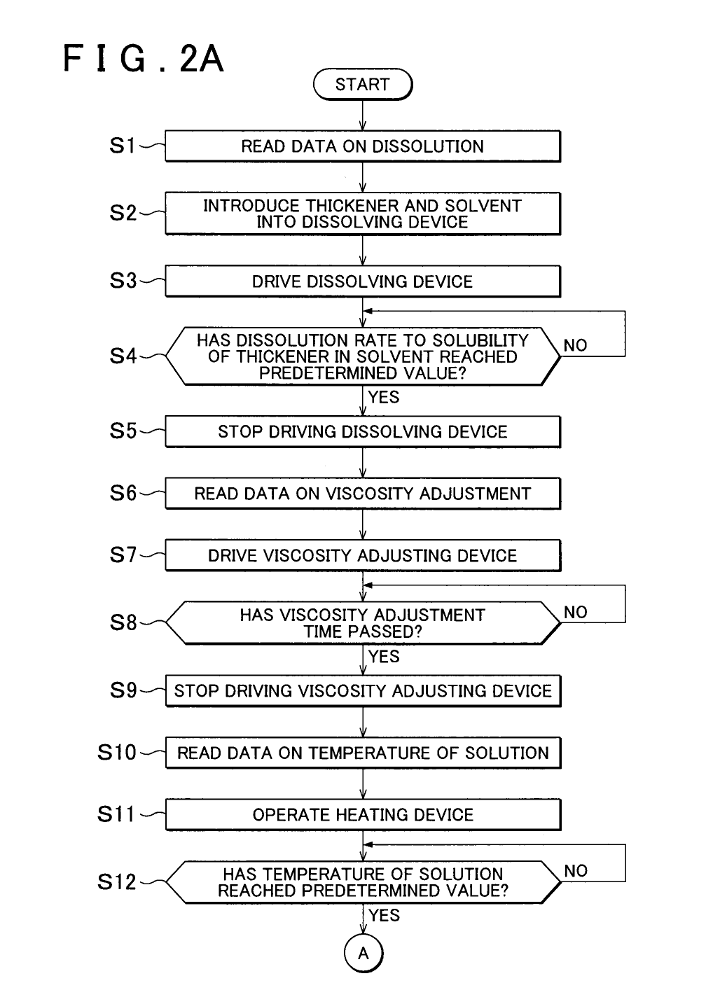

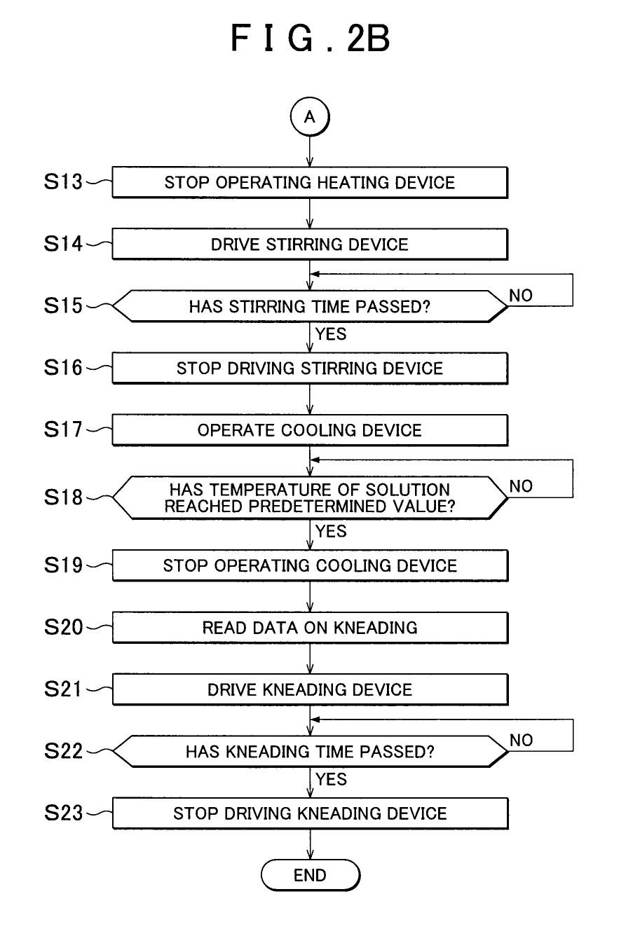

Processing that is performed by the control device 8 will be described below with reference to FIGS. 2A and 2B. The control device 8 reads data relating to dissolution of the thickener (step S1 in FIG. 2A) and supplies the thickener, the solvent, etc. into the dissolving device 2 (step S2 in FIG. 2A). The control device 8 drives the dissolving device 2 (step S3 in FIG. 2A), and stops driving the dissolving device 2 (step S5 in FIG. 2A) if the dissolution rate to solubility of the thickener in the solvent has reached a predetermined value (step S4 in FIG. 2A).

Specifically, the control device 8 reads from the memory unit 81 the data showing the relationship between the viscosity of the solution of the thickener and the dissolution rate to solubility of the thickener in the solvent and the data showing the relationship between the viscosity of the solution of the thickener and the dissolution time of the thickener, and supplies a predetermined amount of thickener and a predetermined amount of solvent into the housing of the dissolving device 2. The control device 8 drives the microwave device of the dissolving device 2 to apply microwaves to the solvent in the housing, thereby dissolving the thickener in the solvent. The control device 8 stops driving the microwave device after it drives the microwave device for such a time that the dissolution rate to solubility of the thickener in the solvent reaches the predetermined value.

Referring to FIG. 5, “μ” represents the viscosity of the solution of the thickener, and “μo” represents the viscosity of the solution of the thickener immediately after the thickener is added to the solvent, i.e., at the time the thickener has not been dissolved in the solvent. Namely, “μo” represents the viscosity of the solution of the thickener at the time the dissolution rate to solubility is 0%. If the dissolution rate to solubility increases to 80%, the viscosity μ of the solution of the thickener increases to μg (>μo). If the thickener has been dissolved in the solvent to saturation, that is, if the dissolution rate to solubility increases to 100%, the viscosity p of the solution of the thickener increases to μs (>μg). In the case of driving the microwave device until the dissolution rate to solubility of the thickener in the solvent increases to 80%, the drive time for the microwave device, namely the thickener dissolution time T, is Tg, namely the time it takes for the viscosity μ of the solution of the thickener to increase from μo to μg, as shown in FIG. 6.

Dissolution using microwaves is performed by vibrating the solvent by microwave radiation and thus causing the solvent to penetrate the thickener. A desirable frequency band of the microwaves is a frequency band in which the solvent tends to absorb energy of the microwaves. For example, a frequency band from 0.9 GHz to 400 GHz is used in the case of using water as the solvent.

The thickener may be dissolved in the solvent by stirring as in conventional examples. In the present embodiment, however, the thickener is dissolved in the solvent by vibrating the solvent with microwaves. This is because the thickener can be more efficiently dissolved in the solvent by using microwave vibrations than by using a stirring force or by heating such as heating of the solvent to, e.g., a high temperature, as shown in FIG. 6.

That is, the time T required to adjust the viscosity μ of the solution of the thickener to target viscosity μs is T12 in the case of using a stirring force, and T13 (>T12) in the case of heating. However, the use of microwaves can reduce the time T to T11 (<T12<T13). Dissolution using microwaves therefore requires less electric power than dissolution using a stirring force.

The control device 8 then reads data relating to viscosity adjustment (step S6 in FIG. 2A) and drives the viscosity adjusting device 3 (step S7 in FIG. 2A). The control device 8 determines if a predetermined viscosity adjustment time has passed (step S8 in FIG. 2A), and stops driving the viscosity adjusting device 3 if the predetermined viscosity adjustment time has passed (step S9 in FIG. 2A).

Specifically, the control device 8 drives the ultrasonic device of the viscosity adjusting device 3 to apply ultrasonic waves to the solution of the thickener in the housing for the predetermined viscosity adjustment time so as to adjust the viscosity of the solution of the thickener. The control device 8 stops driving the ultrasonic device after it drives the ultrasonic device for such a time that the viscosity of the solution of the thickener reaches a predetermined value.

Viscosity adjustment of the solution of the thickener will be described. As shown in FIG. 7, the viscosity ν of the final slurry of the active material is proportional to the viscosity μ of the solution of the thickener. The viscosity ν of the slurry of the active material can therefore be adjusted to a predetermined range of νa to νb by adjusting the viscosity μ of the solution of the thickener to a predetermined value. The predetermined range of νa to νb can be decided based on the balance between the initial battery performance and the practicability of the steps of applying and drying the slurry.

The viscosity μ of the solution of the thickener is adjusted to the predetermined viscosity range of μa to μb shown in FIG. 7 or to a value μc that is higher than the upper limit μb of the predetermined viscosity range by a predetermined value. The viscosity adjustment time required to knead the solution of the thickener and the powder of the active substance etc. to obtain the viscosity of the final slurry of the active material can be reduced by adjusting the viscosity μa of the solution of the thickener to the predetermined viscosity range of pa to μb, which is close to the viscosity of the final slurry of the active material. The time during which the active substance is subjected to a shear force is therefore reduced, which can reduce damage to the active substance. Even if the viscosity μ of the solution of the thickener is the value μc that is higher than the upper limit μb by the predetermined value, the viscosity μ of the solution of the thickener can be adjusted to the predetermined viscosity range of μa to μb by adding the solvent afterward.

The viscosity of the solution of the thickener may be adjusted by cutting the molecular chains of the thickener with shear energy generated by a stirring force as in conventional examples. In the present embodiment, however, the viscosity of the solution of the thickener is adjusted by cutting the molecular chains of the thickener with collision energy and shear energy which are generated by ultrasonic waves. This is because the viscosity of the solution of the thickener can be more efficiently adjusted by using ultrasonic waves than by using a stirring force, as shown in FIG. 8.

That is, the time T required to adjust the viscosity μ of the solution of the thickener to target viscosity μp is T2 in the case of using a stirring force. However, the use of ultrasonic waves can reduce the time T to T1 (<T2). The viscosity adjustment using ultrasonic waves therefore requires less electric power than the viscosity adjustment using a stirring force. The viscosity μ of the solution of the thickener decreases with an increase in viscosity adjustment time T and eventually becomes equal to the viscosity of water.

Subsequently, the control device 8 reads data relating to the temperature of the solution of the thickener (step S10 in FIG. 2A) and operates the heating device 4 (step S11 in FIG. 2A). The control device 8 determines if the temperature of the solution of the thickener has reached a predetermined value (step S12 in FIG. 2A), and stops operating the heating device 4 if the temperature of the solution of the thickener has reached the predetermined value (step S13 in FIG. 2B).

Specifically, the control device 8 reads from the memory unit 81 the data showing the relationship between the viscosity of the solution of the thickener and the temperature of the solution of the thickener, and applies a current to the electrical heating wire of the heating device 4 to cause the electrical heating wire to generate heat. The control device 8 stops applying a current to the electrical heating wire of the heating device 4 when the temperature of the solution of the thickener in the housing has reached the predetermined value and the viscosity of the solution of the thickener has been temporarily reduced.

The control device 8 then drives the stirring device 5 (step S14 in FIG. 2B). The control device 8 determines if a predetermined stirring time has passed (step S15 in FIG. 2B), and stops driving the stirring device 5 if the predetermined stirring time has passed (step S16 in FIG. 2B).

Specifically, the control device 8 drives the motor of the stirring device 5 to rotate the stirring blades for the predetermined stirring time so that the stirring device 5 mixes the solution of the thickener and the powder of the active substance introduced into the housing to produce the first mixture, and stirs the first mixture to produce the second mixture. The control device 8 stops driving the motor when the stirring blades have been rotated for the predetermined stirring time.

The control device 8 then operates the cooling device 6 based on the data that has been read earlier, i.e., the data relating to the temperature of the solution of the thickener (step S17 in FIG. 2B). The control device 8 determines if the temperature of the solution of the thickener has reached a predetermined value (step S18 in FIG. 2B), and stops operating the cooling device 6 if the temperature of the solution of the thickener has reached the predetermined value (step S19 in FIG. 2B).

Specifically, the control device 8 operates the heat pump of the cooling device 6 based on the data showing the relationship between the viscosity of the solution of the thickener and the temperature of the solution of the thickener. The control device 8 stops operating the heat pump of the cooling device 6 when the temperature of the solution of the thickener in the housing has reached the predetermined value and the viscosity of the solution of the thickener has been brought back to the viscosity adjusted by the viscosity adjusting device 3.

The control device 8 then reads data relating to kneading of the mixture of the solution of the thickener and the powder of the active substance etc. (step S20 in FIG. 2B), and drives the kneading device 7 (step S21 in FIG. 2B). The control device 8 determines if a predetermined kneading time has passed (step S22 in FIG. 2B). If the predetermined kneading time has passed, the control device 8 stops driving the kneading device 7 (step S23 in FIG. 2B), whereby final slurry of the active material is produced.

Specifically, the control device 8 reads from the memory unit 81 data on the kneading time, and drives the motor to rotate the stirring blades for a predetermined kneading time so that the kneading device 7 kneads the second mixture supplied into the housing. The control device 8 stops driving the motor when the stirring blades have been rotated for the predetermined kneading time.

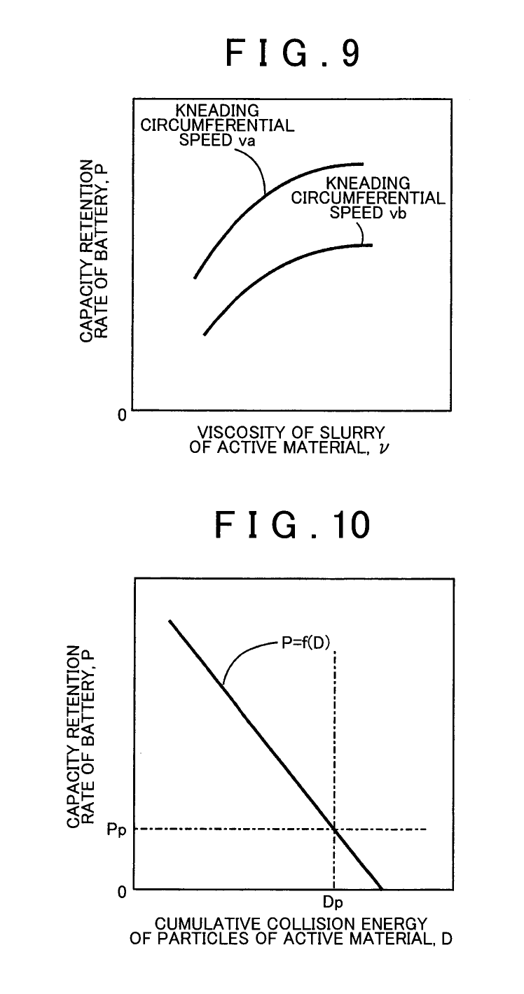

Setting of the kneading index and the kneading conditions will be described. As shown by the experimental result of FIG. 9, the capacity retention rate P of the battery, i.e., durability (repeating charge-discharge characteristics) of the battery, increases as the viscosity ν of the slurry of the active material increases. However, increasing the kneading circumferential speed v of the stirring blades of the kneading device 7 (va<vb) reduces the capacity retention rate P of the battery even if the kneading is performed to obtain the same viscosity ν of the slurry of the active material.

As the kneading circumferential speed v of the stirring blades increases, the particles of the active material collide with the stirring blades more frequently during kneading, and therefore have a higher probability of being damaged. If the particles of the active material are damaged and broken into smaller particles, the overall surface area of the particles is increased, and decomposition of the electrolyte is facilitated. The capacity retention rate P of the battery is thus significantly associated with damage to the particles of the active material.

Factors in the damage to the particles of the active material include the kneading time t for the active material and the solid content rate (solid content/(solid content+liquid content)) η of the active material in addition to the kneading circumferential speed v of the stirring blades. Accordingly, the number of collisions of the particles of the active material is obtained based on a known mean free path by using a model of the particles of the active material which move freely in a predetermined space. As given by the following formula (1), cumulative collision energy D of the particles of the active material serving as the kneading index can be obtained by multiplying the kinetic energy mv²/2 of the particles of the active material, the number of collisions √(2)·η·σ·v of the particles of the active material, and the kneading time t for the active material. The damage state of the particles of the active material due to kneading can thus be predicted before kneading is performed.

$$D = ( \frac{{mv}^{2}}{2} ) \times ( \sqrt{2} ησ v ) \times ( t ) \qquad ( 1 )$$

where “D” represents the cumulative collision energy of the particles of the active material, “m” represents the weight of a single particle of the active material, “v” represents the kneading circumferential speed of the stirring blades, “η” represents the solid content rate of the active material, “σ” represents the mean particle size of the particles of the active material, and “t” represents the kneading time for the active material.

The relationship between the capacity retention rate P of the battery and the cumulative collision energy D of the particles of the active material is obtained as shown in FIG. 10. This relationship is obtained by adjusting the kneading circumferential speed v of the stirring blades, the solid content rate η of the active material (the solid content rate is adjusted by changing the ratio of the solid content to the liquid content), and the kneading time t for the active material which are the factors in the damage to the particles of the active material. The relational expression P=f(D) is obtained, and cumulative collision energy Dp of the particles of the active material which corresponds to a minimum required capacity retention rate Pp of the battery is obtained. Kneading conditions are set so that the cumulative collision energy D of the particles of the active material is equal to or lower than Dp. That is, the kneading circumferential speed v of the stirring blades, the solid content rate η of the active material, and the kneading time t for the active material are set so that the cumulative collision energy D of the particles of the active material is equal to or lower than Dp.

As described above, the number of collisions of the particles of the active material is obtained based on the mean free path of the particles of the active material by using the model of the particles of the active material which move freely in a predetermined space. The cumulative collision energy of the particles of the active material can be obtained by multiplying the number of collisions of the particles of the active material, the kinetic energy of the active material, and the kneading time for the active material, and the cumulative collision energy thus obtained can be used as an index of durability of the battery. Since the damage state of the particles of the active material due to kneading can be predicted before kneading is performed, kneading can be performed such that the particles of the active material are less likely to be damaged. A durable battery can therefore be manufactured.

According to the apparatus 1 for manufacturing an electricity storage material, the solution of the thickener has already been heated when stirred together with the powder of the active substance. Accordingly, the viscosity of the solution of the thickener is reduced, and the wetting rate of the powder of the active substance with the solution of the thickener is increased. Since the powder of the active substance is easily wetted with the solution of the thickener, the mixture of the solution of the thickener and the powder of the active substance is not deposited in the manufacturing apparatus 1 and can therefore be smoothly fed. Due to the improved wettability of the powder of the active substance with the solution of the thickener, the powder of the active substance is quickly dispersed in the solution of the thickener, and damage to the powder of the active substance can be suppressed. Since the powder of the active substance is uniformly dispersed in the solution of the thickener, quality of the electrodes can be improved, and battery performance can be enhanced.

In the above embodiment, the heating device 4 is placed between the viscosity adjusting device 3 and the stirring device 5. However, the heating device 4 may be placed between the dissolving device 2 and the viscosity adjusting device 3. In this case, the viscosity of the solution of the thickener has already been reduced when viscosity adjustment of the solution of the thickener is performed. Accuracy of viscosity adjustment by the viscosity adjusting device 3 can thus be improved.

The heating device 4 may be configured as follows. The stirring device 5 may include an electrical heating wire etc. so as to have a heating function. In this case, since the stirring device 5 stirs the solution of the thickener together with the powder of the active substance and heats the solution of the thickener, manufacturing efficiency can be improved. Moreover, since no separate heating device is needed, an increase in apparatus cost can be suppressed.

The viscosity adjusting device 3 may include a high-power ultrasonic device so as to have a heating function. In this case, since the viscosity adjusting device 3 adjusts the viscosity of the solution of the thickener and heats the solution of the thickener, manufacturing efficiency can be improved. Moreover, since no separate heating device is needed, an increase in apparatus cost can be suppressed. The viscosity adjusting device 3 may include stirring blades instead of the ultrasonic device. In this case, the viscosity adjusting device 3 includes an electrical heating wire etc. so as to have a heating function.

The dissolving device 2 may have a heating function that is carried out by the microwave device. In this case, since the dissolving device 2 dissolves the thickener in the solvent and heats the solution of the thickener, manufacturing efficiency can be improved. Moreover, since no separate heating device is needed, an increase in apparatus cost can be suppressed. The dissolving device 2 may include stirring blades instead of the microwave device. In this case, the dissolving device 2 includes an electrical heating wire etc. so as to have a heating function.

In the above embodiment, the cooling device 6 is placed between the stirring device 5 and the kneading device 7. However, the kneading device 7 may include a heat pump so as to have a cooling function. In this case, since the viscosity of the solution of the thickener is brought back to the viscosity adjusted by the viscosity adjusting device 3, dispersibility of the powder of the active substance in the solution of the thickener can be improved. Since the powder of the active substance is uniformly dispersed in the solution of the thickener by kneading in the kneading device 7, quality of the electrodes can be improved, and battery performance can be enhanced. The cooling device 6 may be placed after the kneading device 7. The apparatus 1 for manufacturing an electricity storage material may not include the cooling device 6 and the solution of the thickener may be naturally cooled.

The above embodiment is described with respect to the case of manufacturing the active material for negative electrodes of lithium ion secondary batteries. However, the present invention is also applicable to the case of manufacturing an active material for positive electrodes of lithium ion secondary batteries. In this case, microwaves are applied when a binder such as polyvinylidene fluoride is dissolved in a solvent such as N-methylpyrrolidone. However, no ultrasonic waves are applied in the case where a conductive agent such as acetylene black is mixed with the solution. This is because the viscosity of the solution can be adjusted according to the amount of conductive agent such as acetylene black to be mixed.

The electricity storage material to which the invention is applied is not limited to the active material for electrodes of lithium ion secondary batteries. The present invention is also applicable to any electricity storage materials such as, e.g., materials for capacitors.

In order to further improve the wetting rate, a surfactant is added to the solution of the thickener to reduce the surface tension of the solution of the thickener and thus increase the wetting angle. A fluorosurfactant can be used as a surfactant that improves wettability of the powder of the active substance with the solution of the thickener, because the fluorosurfactant is chemically stable and is not decomposed during charging and discharging. The use of the fluorosurfactant can thus enhance battery performance.

What is claimed is:

1. An apparatus for manufacturing an electricity storage material, comprising:
a dissolving device that dissolves a thickener in a solvent;
a viscosity adjusting device that adjusts viscosity of a solution produced by dissolving the thickener in the solvent by the dissolving device;
a stirring device that mixes the solution of the thickener adjusted in viscosity by the viscosity adjusting device and powder of an active substance to produce a first mixture, and stirs the first mixture to produce a second mixture;
a heating device that heats the solution of the thickener or the first mixture by the time the stirring device starts stirring the first mixture after the dissolving device produces the solution of the thickener, so that the solution of the thickener contained in the first mixture has already been heated when the stirring device stirs the first mixture; and
a kneading device that kneads the solution of the thickener and the powder of the active substance which are contained in the second mixture produced by the stirring device to produce a third mixture.

2. The apparatus according to claim 1, wherein
the heating device heats the solution of the thickener by the time the stirring device starts mixing the solution of the thickener and the powder of the active substance after the dissolving device produces the solution of the thickener.

3. The apparatus according to claim 2, wherein
the heating device heats the solution of the thickener by the time the viscosity adjusting device completes the viscosity adjustment of the solution of the thickener after the dissolving device produces the solution of the thickener.

4. The apparatus according to claim 3, wherein
the dissolving device also serves as the heating device, and
the dissolving device dissolves the thickener in the solvent and heats the solution of the thickener by applying microwaves.

5. The apparatus according to claim 3, wherein
the viscosity adjusting device also serves as the heating device, and
the viscosity adjusting device adjusts the viscosity of the solution of the thickener and heats the solution of the thickener by applying ultrasonic waves.

6. The apparatus according to claim 1, further comprising:
a cooling device that cools the second mixture or the third mixture after the stirring device stirs the first mixture.

7. The apparatus according to claim 6, wherein
the cooling device cools the second mixture by the time the kneading device starts kneading the second mixture after the stirring device finishes stirring the first mixture.

8. A method for manufacturing an electricity storage material, comprising:
dissolving a thickener in a solvent;
adjusting viscosity of a solution produced by the dissolution of the thickener in the solvent;
mixing the solution of the thickener adjusted in viscosity by the viscosity adjustment and powder of an active substance to produce a first mixture, and stirring the first mixture to produce a second mixture;
heating the solution of the thickener or the first mixture by the time the stirring of the first mixture is started after the solution of the thickener is produced by the dissolution, so that the solution of the thickener contained in the first mixture has already been heated when the stirring of the first mixture is performed; and
kneading the solution of the thickener and the powder of the active substance which are contained in the second mixture produced by the stirring to produce a third mixture.
